(19) United States
(12) Patent Application Publication
(10) Pub. No.: US 2023/0060346 A1
(43) Pub. Date: Mar. 2, 2023

(54) Instrument Case

(71) Applicant: Ramon Noguera, New Hyde Park, NY (US)

(72) Inventor: Ramon Noguera, New Hyde Park, NY (US)

(21) Appl. No.: 17/411,368

(22) Filed: Aug. 25, 2021

(51) Int. Cl. G10G 7/00

(52) U.S. Cl. CPC G10G 7/005

(57) ABSTRACT

The case for a string instrument and a bow can comprise a base shell that defines a first compartment that is configured to receive the string instrument. The first compartment can have an inner surface that is complementary to the shape of the string instrument and is configured to restrict movement of the string instrument along the longitudinal axis and the transverse axis. The base shell can further define a second compartment that is configured to receive the bow. The second compartment can have an inner surface that is complementary to the shape of the bow and is configured to restrict movement of the bow along the longitudinal axis and the transverse axis. A cover can be pivotably coupled to the base shell. In a closed position, the cover and the base shell can cooperate to fully enclose the string instrument and the bow within the case.

### FIELD

This application relates generally to apparatuses for storing string instruments.

### BACKGROUND

Conventional string instrument cases, such as those for violins, violas, cellos, and double basses, have an upper portion that is pivotably coupled to a lower portion. The lower portion defines a cavity that receives the instrument. The upper portion defines a recess that receives one or more bows. On one end of the recess, the case has a cross member that extends across the recess so that the cross member and recess cooperate to define an opening through which a first end of the bow is received. On the opposing end of the recess, a retainer retains the bow against the top case, within the recess. The most common retainer is a bow spinner that is pivotable between a first position, in which the spinner is longitudinally aligned with the bow so that the spinner can be received between the stick and the hair of the bow, and a second position, in which the spinner is oriented transversely to the longitudinal dimension of the bow, thereby inhibiting the movement of the bow from the spinner. A conventional case is disclosed in U.S. Pat. No. 6,866,146, issued to Heesch on Mar. 15, 2005, the entirety of which is hereby incorporated by reference herein.

Care must be taken to ensure that the spinner or other retainer is positioned to retain the bow, or the bow will fall against the instrument, causing cuts, cracks, or other damage to the instrument during transportation of the case. Failure to position the spinner or other retainer to retain the bow is particularly common for novices and schoolchildren. Thus, a case that does not rely on the care of the user to safely retain the bow is desirable. Moreover, the conventional system requires two hands to secure and release the bow, which can often be undesirable.

Moreover, many instrument users, especially novices, use additional equipment such as, for example, grip guides that couple to the bow and assist the user with placement of her hands or shoulder rests that couple to the instrument to properly locate the instrument. Conventional cases do not accommodate the additional equipment while the equipment is coupled to the instrument or bow. This additional equipment takes significant time to set up properly on the instrument and bow, and the equipment must be removed before and attached after each use when storing the instrument in a conventional case.

### SUMMARY

Described herein, in various aspects, is a case for a string instrument and a bow, the string instrument and the bow having respective shapes, the case having a longitudinal axis and a transverse axis. The case can comprise a base shell that defines a first compartment that is configured to receive at least a portion of the string instrument. The first compartment can have an inner surface that is complementary to the shape of the string instrument and can be configured to restrict movement of the string instrument along the longitudinal axis and the transverse axis. A second compartment can be configured to receive at least a portion of the bow. The second compartment can have an inner surface that is complementary to the shape of the bow and can be configured to restrict movement of the bow along the longitudinal axis and the transverse axis. A cover can be pivotably coupled to the base shell. With the cover in a closed position, the cover and the base shell can be configured to cooperate to fully enclose the string instrument and the bow within the case.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

These and other features of the preferred embodiments of the invention will become more apparent in the detailed description in which reference is made to the appended drawings wherein:

FIG. 1 is a top view of a base shell of a case as disclosed herein.

FIG. 2 is a schematic diagram of an end view of the case of FIG. 1, with a cover of the case in an open position.

FIG. 3 is a schematic diagram of a side view of the case as in FIG. 2, with the cover in a closed position.

FIG. 4 is a top view of a base shell of a case as disclosed herein.

FIG. 5 is a top view of a base shell of a case as disclosed herein.

FIG. 6 is a schematic cross sectional diagram of a first compartment of the base shell of the case with a string instrument and accessory therein.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a”, “an,” and “the” include plural references unless the context clearly dictates otherwise. Thus, for example, reference to “a compartment” includes one or more of such compartments, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

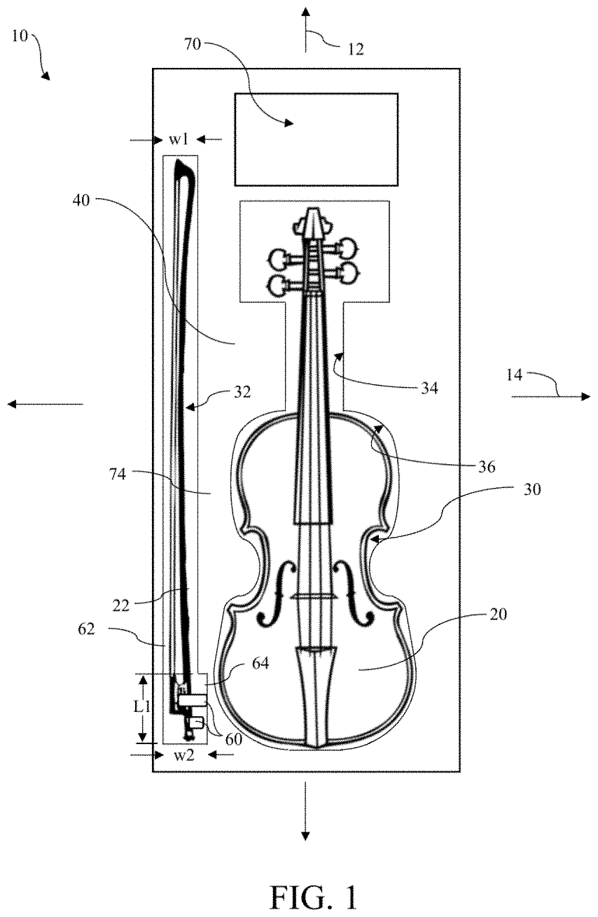

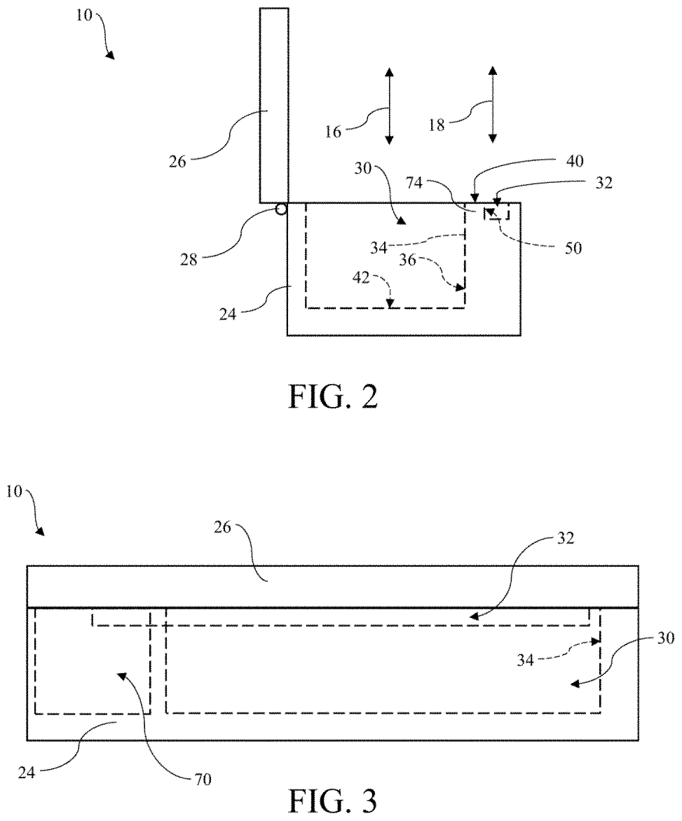

Referring to FIG. 1, a case 10 having a longitudinal axis 12 and a transverse axis 14 that is perpendicular to the longitudinal axis. The case 10 can be configured to receive and enclose a string instrument 20 and a bow 22. Each of the string instrument 20 and the bow 22 can have a respective shape. In some optional aspects, the string instrument 20 can be a violin, viola, cello, or double bass, and the bow can be a bow that is configured for use with the particular string instrument. That is, in some optional aspects, the case 10 can be a case that is configured to receive a violin or viola and a violin or viola bow. In further optional aspects, the case 10 can be a cello case that is configured to receive a cello or bass and a cello or bass bow.

The case 10 can comprise a base shell 24 and a cover 26 that is pivotably coupled to the base shell. For example, a hinge 28, such as, for example, but not limited to, one or more butt hinges, one or more piano hinges, or a living hinge. The hinge 28 can optionally couple to each of the base shell 24 and cover 26 at respective adjacent longitudinally extending edges. The base shell 24 and cover 26 can optionally have equal or substantially equal lengths along the longitudinal axis 12 and widths along the transverse axis 14. A latch (not shown) can be positioned on a side of the case opposing the hinge 28 for retaining the cover 26 in a closed position (FIG. 3).

The base shell 24 can define a first compartment 30 that is configured to receive at least a portion of the string instrument 20. For example, the first compartment 30 can be configured to receive the string instrument 20 as the instrument is lowered along a first vertical axis 16 that is perpendicular to each of the longitudinal and transverse axes 12, 14.

The first compartment 30 can have an inner surface 34 that is complementary to the shape of the string instrument 20. In this way, the inner surface 34 of the first compartment 30 can restrict movement of the string instrument 20 along the longitudinal axis 12 and the transverse axis 14. For example, in some optional aspects, the inner surface 34 of the first compartment 30 can comprise a vertically extending, or generally vertically extending, peripheral or circumferential surface 36 that traces peripheral or circumferential side surfaces of the string instrument. The case 10 can optionally comprise padding along at least a portion of the first compartment 30 that absorbs shock to protect the string instrument 20. In exemplary aspects, it is contemplated that the padding can comprise foam, such as polystyrene foam (e.g., STYROFOAM).

The base shell 24 can have an upper surface portion 40. Optionally, the upper surface portion can be planar or generally planar. In some aspects, the first compartment can have a depth between a bottom surface 42 of the first compartment 30 and the upper surface portion 40 of the base shell 24. Optionally, the depth can be sufficient to receive an entirety of the string instrument within the first compartment. As should be understood, the depth of the first compartment 34 need not be uniform across the first compartment. In further aspects, only a portion of the string instrument can be received within the first compartment and a remainder of the string instrument can extend above the upper surface portion 40. In these aspects, it is contemplated that the cover can define one or more recessed portions that, in a closed position, are configured to complementarily receive corresponding portions of the string instrument that extend above the upper surface portion 40. Accordingly, in some aspects, the depth of the first compartment 30 can be less than 3 inches, less than 2 inches, or about 2 inches.

The base shell 24 can further define a second compartment 32 that is configured to receive at least a portion of (or an entirety of) the bow 22. The second compartment 32 can have an inner surface 50 that is complementary to the shape of the bow 22 and is configured to restrict movement of the bow 22 along the longitudinal and transverse axes 12, 14. In some aspects, the second compartment 32 can be spaced from the first compartment 30 along the transverse axis 14. In some aspects, the second compartment 32 can pennit insertion into and removal of the bow 22 along a second vertical axis 18 that is parallel to the first vertical axis 16. Although shown in FIG. 1 with the hairs spaced transversely to the stick, it is contemplated that the bow can be received with the hairs and stick spaced along the second vertical axis 18. In some optional aspects, the second compartment 32 can be at least two inches deep, at least one inch deep, or about one inch deep.

The first compartment 30 can be oriented along a first axis 52. In some optional aspects, the first compartment 30 can be symmetric about a plane 54 that includes the first axis 52.

In some optional aspects, the first axis 52 can be parallel to the longitudinal axis 12 of the case 10. In further optional aspects, the first axis 52 can form an acute angle with the longitudinal axis 12 of the case 10.

The second compartment 32 can be oriented along a second axis 56. In some optional aspects, the second axis 56 can be parallel to the first axis 52. In further optional aspects, the second axis 56 can form an acute angle with the first axis 52.

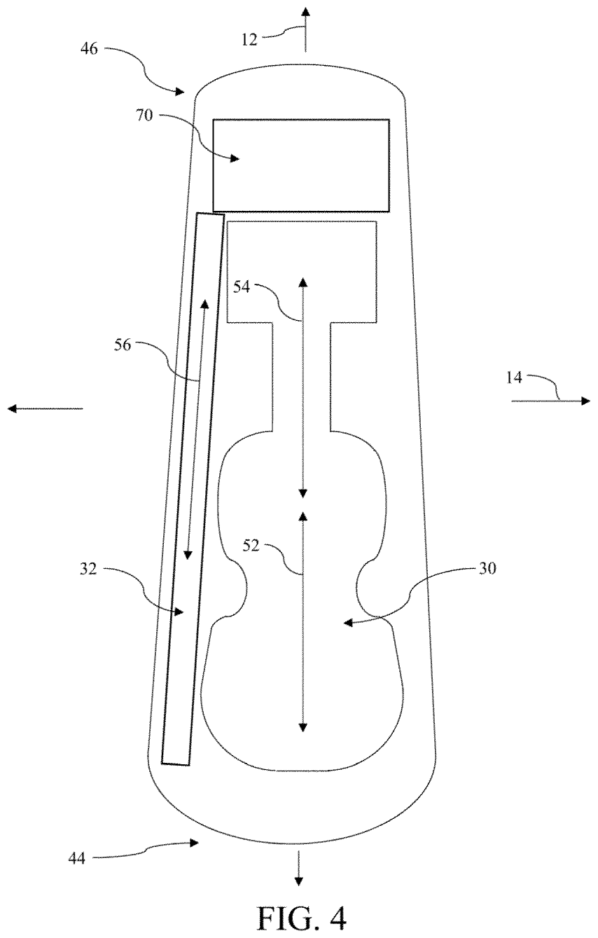

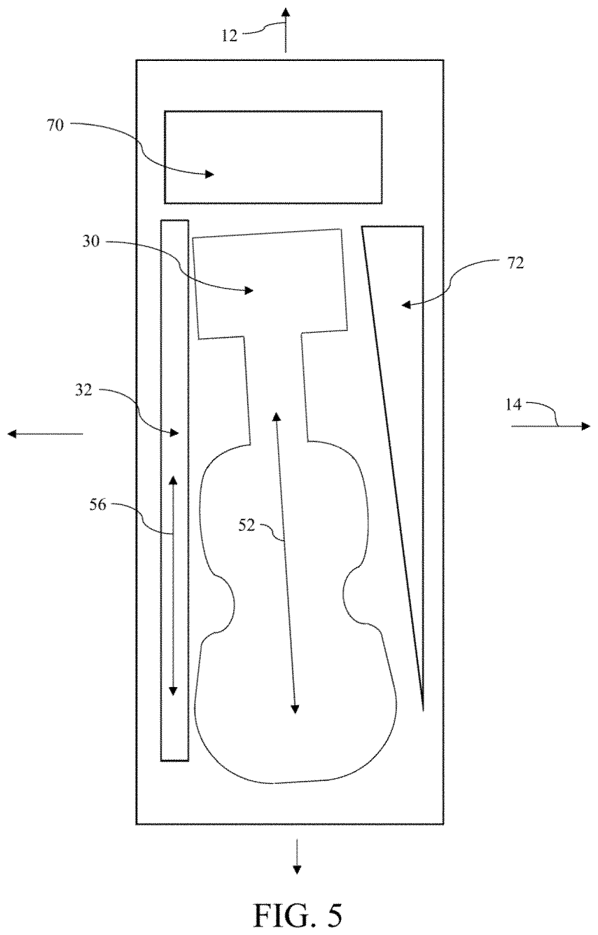

As shown in FIG. 4, the case can have a first end 44 and an opposed second end 46 that are spaced along the longitudinal axis. The case 10 can have a width along the transverse axis. In some optional aspects, the width can have a taper between the first end 44 and the second end 46 of the case. In some aspects, the taper can be continuous from the first end 44 to the second end 46. In further respects, the taper can extend only along a portion of the case 10 from the first end 44 to the second end 46.

A grip guide 60 can be coupled to the bow 24 for encouraging proper hand placement. One example of such a grip guide is a BOW BUDDY grip guide provided by Strings 4 Things, LLC. The second compartment 32 can be configured to receive the bow 22, or a portion thereof, with the grip guide 60 attached to the bow. For example, the second compartment 32 can comprise a main portion 62 that is configured to receive the bow and an accessory portion 64 that extends from the main portion 62, outwardly from the second axis. In some optional aspects, the main portion 62 can have a width, w1, of about 1 inch or less than 1 inch (e.g., about % inch). The main portion 62 and accessory portion 64 of the second compartment 32 can cooperatively have a width, w2, of about 2 inches, less than 2 inches, or about 1¾ inches. In some aspects, the accessory portion 64 can have a length L1 along the longitudinal axis 12 of at least 3 inches, at least 4 inches, or about 4 inches, or less than 6 inches. It is contemplated that by accommodating the grip guide 60, the disclosed cases can avoid the need for attaching or removing the grip guide each time the bow is to be used or stored. It is further contemplated that the disclosed cases can discourage the placement of unsecured grip guides within case, which can lead to damage of the instrument.

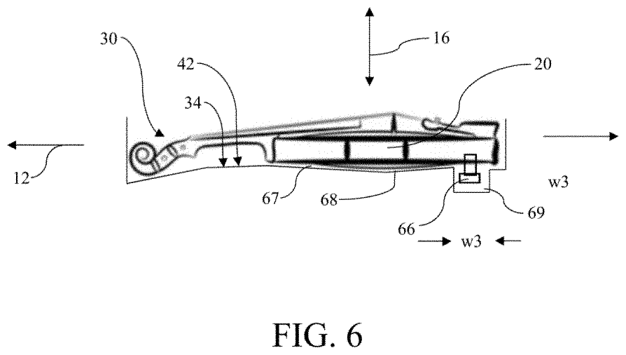

A shoulder rest 66 can be coupled to the string instrument 20 (e.g., a violin or viola). In some aspects, and as shown in FIG. 6, the first compartment 30 can be configured to receive the string instrument 20 with the shoulder rest 66 coupled thereto. For example, in some aspects, the first compartment 30 can define a main portion 67 that is configured to receive the string instrument and a receiving portion 69 having an increased dimension along the transverse axis 14 (FIG. 1) and/or an increased depth along the first vertical axis 16 where the first compartment 30 receives the shoulder rest 66. In some aspects, the main body portion 67 can have a lower surface 68 against which the string instrument rests, and the receiving portion 69 can extend from the main body portion 67 to accommodate the shoulder rest 66 when the shoulder rest 66 is coupled to the violin in a use position. In exemplary, optional aspects, the receiving portion 69 of the first compartment 30 can have an increased depth, d1, of at least 1 inch or at least 2 inches (e.g., about 2 inches) along the vertical axis 16 and a width, w3, along the longitudinal axis 12 of at least 3 inches or at least 4 inches (e.g., about 4 inches). It is contemplated that by accommodating the shoulder rest 66, the disclosed cases can avoid the need for attaching or removing the shoulder rest each time the string instrument is to be used or stored. It is further contemplated that the disclosed cases can discourage the placement of unsecured shoulder rests within case, which can lead to damage of the instrument.

In some optional aspects, the base shell 24 can further define a third compartment 70, wherein the third compartment can optionally have a width relative to the longitudinal axis 12 of at least 3 inches or at least 5 inches, or about 5 inches. The third compartment 70 can optionally have a length of at least 3 inches, or at least 5 inches, or at least 9 inches, or about 3 inches, or about 5 inches, or about 9 inches. The third compartment 70 can optionally have a depth of at least 2 inches, or between 2 and 3 inches, or about 2.5 inches, or from about 1 inch to about 3 inches, or about 1.5 inches. In some optional aspects, the third compartment can be spaced from the first compartment along the longitudinal axis 12. The third 70 compartment can optionally be positioned between the first compartment and the second end 46. In further optional aspects, the base shell can define a fourth compartment 72. The fourth compartment 72 can optionally have a tapered width along the longitudinal axis 12. The fourth compartment 72 can optionally have a depth of at least 2 inches, at least 3 inches, or about 3.5 inches. The third and fourth compartments 70, 72 can be configured to store accessories such as, for example, rosin and strings.

The base shell 24 of the case 10 can define a wall 74 between the first compartment and the second compartment. Optionally, the wall 74 can extend an entirely of a shared length of the first compartment 30 and second compartment 32 along the longitudinal axis 12. The wall 74 can be defined at least partly by the upper surface portion 40 and respective portions of the inner surfaces 34, 50 of the first and second compartments 30, 32.

In some aspects, the cover 26 can extend across the first and second compartments 30, 32. Accordingly, the cover 26 can retain the string instrument 20 within the first compartment 30 and the bow 22 within the second compartment 32. Accordingly, in some aspects, the case can omit a retaining feature such as, for example, a spinner, that is configured to retain the bow in the second compartment. However, in further aspects, it is contemplated that the case can comprise a spinner or other retaining feature that retains the bow in the second compartment. Optionally, it is contemplated that a surface of the cover 26 can cooperate with the inner surfaces of the first and second compartments 30, 32 to enclose and/or retain the string instrument 20 and the bow 22. In some optional aspects, it is contemplated that the string instrument 20 and/or the bow 22 can extend upwardly from the upper surface portion 40 into corresponding recesses within the cover 26. Alternatively, it is contemplated that such recesses can be omitted, and the cover 26 can retain the string instrument 20 and the bow 22 such that the string instrument and/or the bow are completely or substantially completely within their respective compartments.

A method of using the case 10 can comprise positioning the string instrument 20 within the first compartment 30. The string instrument can be a violin, a viola, a cello, or a double bass. The method can further comprise positioning a bow 22 within the second compartment 32. Optionally, the string instrument 20 can be inserted into the first compartment 30 along the first vertical axis 16, and the bow 22 can be inserted into the second compartment 32 along the second vertical axis 18, which can be parallel to the first vertical axis. In some optional aspects, a shoulder rest can be coupled to the string instrument, and the shoulder rest and string instrument can be inserted into the first compartment, optionally, with the shoulder rest coupled to the string instrument. In some optional aspects, a grip guide can be coupled to the bow, and the bow and grip guide can be inserted into the second compartment.

The cover 26 can be moved from the open position (FIG. 3) to the closed position (FIG. 4) with the instrument 20 and bow 22 within the case 10 so that the cover and the base shell 24 cooperate to fully enclose the string instrument and the bow within the case. The method can further comprise moving the cover from the closed position to the open position. With the cover in the open position, the string instrument can be removed from the first compartment along the vertical axis, and the bow can be removed from the second compartment along the second vertical axis.

It is contemplated that insertion and removal of the instrument and bow can be performed with a single hand. Moreover, opening and closing of the case can optionally be performed with a single hand. Accordingly, the user does not need to use two hands for stowing and retaining the bow in the second compartment. Further, with the cover in the closed position, the bow can be retained and held safely away from the string instrument to prevent contact therebetween without requiring an additional step of locking the bow in place.

Although the foregoing invention has been described in some detail by way of illustration and example for purposes of clarity of understanding, certain changes and modifications may be practiced within the scope of the appended claims.

What is claimed is:

1. A case for a string instrument and a bow, the string instrument and the bow having respective shapes, the case having a longitudinal axis and a transverse axis, the case comprising:
a base shell that defines:
a first compartment that is configured to receive at least a portion of the string instrument, wherein the first compartment has an inner surface that is complementary to the shape of the string instrument and configured to restrict movement of the string instrument along the longitudinal axis and the transverse axis; and
a second compartment that is configured to receive at least a portion of the bow, wherein the second compartment has an inner surface that is complementary to the shape of the bow and configured to restrict movement of the bow along the longitudinal axis and the transverse axis; and
a cover that is pivotably coupled to the base shell, wherein with the cover in a closed position, the cover and the base shell are configured to cooperate to fully enclose the string instrument and the bow within the case.

2. The case of claim 1, wherein the second compartment is spaced from the first compartment along the transverse axis.

3. The case of claim 1, wherein the first compartment is oriented along a first axis that is parallel to the longitudinal axis of the case.

4. The case of claim 1, wherein the first compartment is oriented along a first axis that forms an acute angle with the longitudinal axis of the case

5. The case of claim 1, wherein the first compartment is oriented along a first axis, wherein the second compartment is elongate along a second axis that forms an acute angle with the first axis.

6. The case of claim 1, wherein the first compartment is oriented along a first axis, wherein the second compartment is elongate along a second axis that is parallel to the first axis.

7. The case of claim 1, wherein the case has a first end and an opposed second end that are spaced along the longitudinal axis, wherein the case has a width along the transverse axis, wherein the width has a taper between the first end and the second end of the case.

8. The case of claim 1, wherein the second compartment is further configured to receive the bow with a grip guide coupled thereto.

9. The case as in claim 1, wherein the first compartment is configured to accommodate the string instrument and a shoulder rest coupled thereto.

10. The case as in claim 1, wherein the base shell further defines a third compartment, wherein the third compartment has dimensions of at least 5 inches by at least 5 inches.

11. The case as in claim 1, wherein the base shell defines a wall between the first compartment and the second compartment.

12. The case as in claim 11, wherein the base shell defines a generally planar upper surface portion, wherein the wall is at least partly defined by the generally planar upper surface portion and respective portions of the inner surfaces of the first and second compartments.

13. The case as in claim 1, wherein the case does not comprise a retaining feature that is configured to retain the bow in the second compartment.

14. The case as in claim 1, wherein with the cover in an open position, the first compartment permits removal or insertion of the string instrument along a first vertical axis and the second compartment permits removal or insertion of the bow along a second vertical axis, wherein the first and second vertical axes are perpendicular to the longitudinal axis and the transverse axis.

15. A method comprising:
a. positioning a string instrument within a first compartment of a base shell of a case, the case having a longitudinal axis and a transverse axis that is perpendicular to the longitudinal axis, the case further comprising a cover that is pivotably coupled to the base shell, wherein the string instrument is positioned within the first compartment with the cover in an open position, wherein the first compartment has an inner surface that is complementary to the shape of the string instrument and configured to restrict movement of the string instrument along the longitudinal axis and the transverse axis;
b. positioning a bow within a second compartment of the base shell of the case, wherein the bow is positioned within the second compartment with the cover in the open position, wherein the second compartment has an inner surface that is complementary to the shape of the bow and configured to restrict movement of the bow along the longitudinal axis and the transverse axis:
c. moving the cover from the open position to a closed position, wherein in the closed position, the cover and the base shell cooperate to fully enclose the string instrument and the bow within the case.

16. The method as in claim 15, wherein the string instrument is a violin, a viola, a cello, a bass, or a double bass.

17. The method as in claim 15, wherein the string instrument is coupled to a shoulder rest, and wherein the string instrument and the shoulder rest are positioned within the first compartment.

18. The method as in claim 15, wherein the bow is coupled to a grip guide, and wherein the bow and the grip guide are positioned within the second compartment.

19. The method as in claim 15, wherein the string instrument is inserted into the first compartment along a first vertical axis, wherein the bow is inserted into the second compartment along a second vertical axis, and wherein the first and second vertical axes are perpendicular to the longitudinal axis and the transverse axis of the case.

20. The method as in claim 19, further comprising:
a. moving the cover from the closed position to the open position;
b. removing the string instrument from the first compartment along the first vertical axis; and
c. removing the bow from the second compartment along the second vertical axis.
